(19) United States
(12) Patent Application Publication
(10) Pub. No.: US 2017/0001855 A1
(43) Pub. Date: Jan. 5, 2017

(54) RIDING GIRTH

(71) Applicant: ACAVALLO S.R.L., Lonato del Garda, BRESCIA (IT)

(72) Inventor: MAURO BENETTI, LONATO DEL GARDA, BRESCIA (IT)

(73) Assignee: ACAVALLO S.R.L., LONATO DEL GARDA, BRESCIA (IT)

(21) Appl. No.: 15/115,096

(22) PCT Filed: Jan. 26, 2015
(86) PCT No.: PCT/IB2015/050566

§ 371 Date: Jul. 28, 2016

(30) Foreign Application Priority Data
Jan. 31, 2014 (IT) BS2014U00000

(51) Int. Cl. B68C 1/14

(52) U.S. Cl. CPC B68C 1/14

(57) ABSTRACT

The invention relates to a riding girth comprising a central portion (10) from which two lateral bands (12) extend suitable to encircle the chest of the horse up to the connection to the saddle. On the outer side of the central portion (10) a coupling element (14) is made for attaching the loop of a strap of the martingale, harness or other operating instrument. Said coupling element (14) comprises a base (16) and a plate-shaped elastic hook (18) which extends from said base (16) and which permits the insertion/extraction of the loop of the strap into and from the coupling element thanks to the elastic lifting of an end portion thereof relative to the base (16).

The present invention relates to a riding girth.

As it is known, the girth is a harness used for riding, which has the purpose of fixing the saddle on the horse. It surrounds the chest of the animal, and connects to the attachments of the saddle.

Most of the currently used girths have in the central part a ring, a snap hook or a strap fitted with a buckle for connecting to the loop of the fastening strap to the martingale, harness, or to other fittings.

All these coupling systems are dangerous because when jumping the horseshoe may catch it with its rear part, where a steel crampon is usually inserted in the ring, hook, or strap of the girth. Such drawback is very dangerous and in most cases produces a disastrous fall of the horse and rider.

Therefore, the object of the present invention is to propose a girth able to overcome such a drawback.

A further purpose of the present invention is to provide a girth which is particularly comfortable for the horse.

The technical characteristics of the invention according to the aforesaid aims can be seen clearly from the contents of the following claims and the advantages of the same will be more clearly comprehensible from the detailed description below, made with reference to the attached drawings, showing one or more embodiments by way of non-limiting examples, wherein:

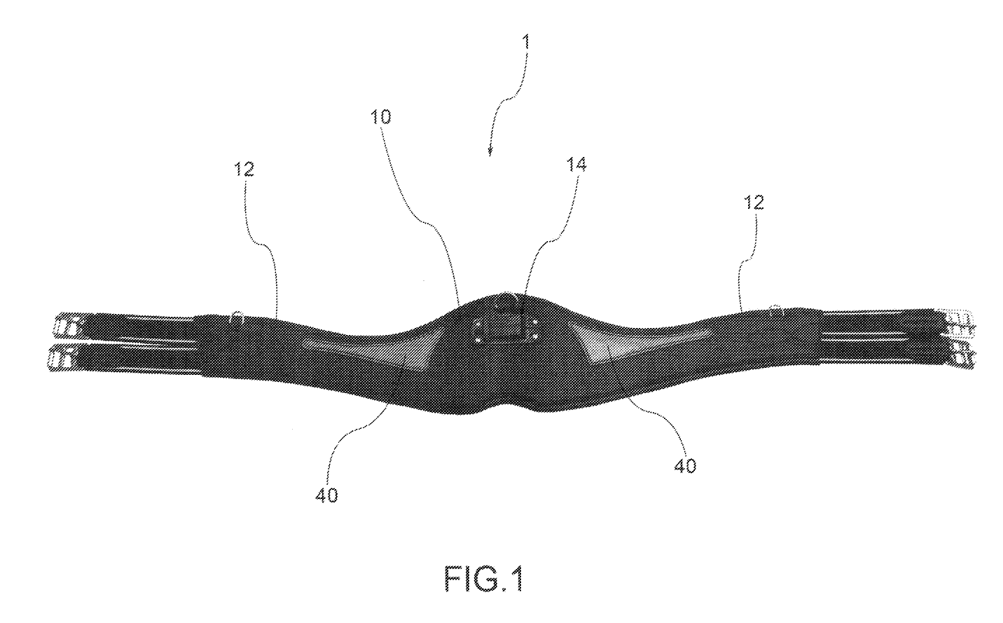

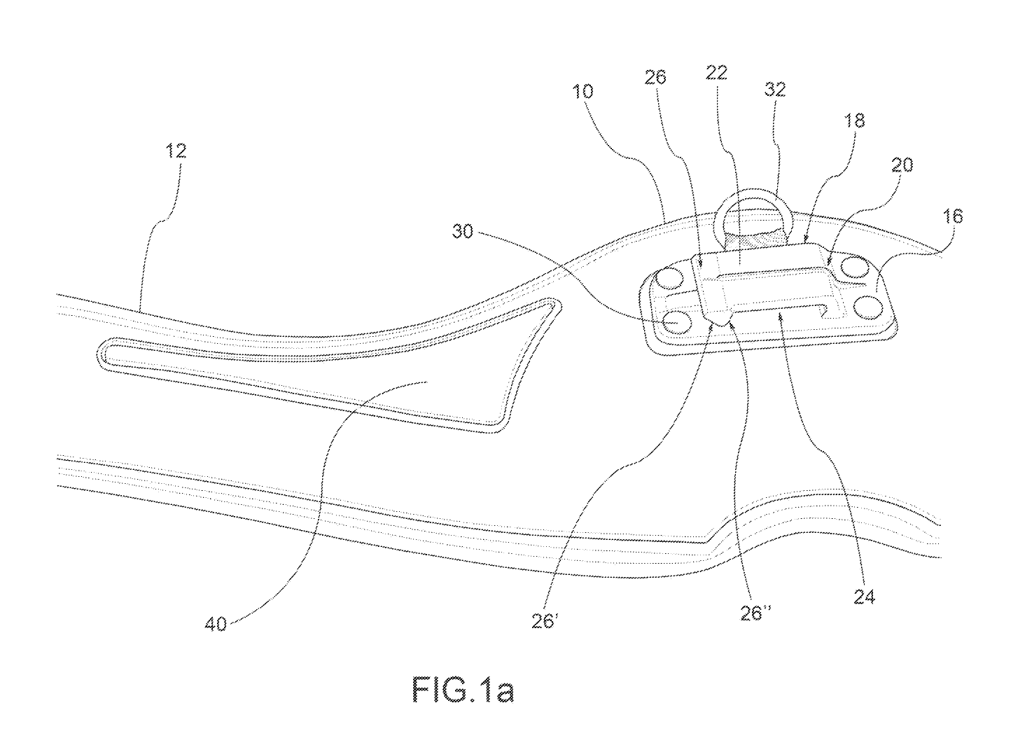

FIG. 1 is a view of the outside of the girth according to the invention, in a first embodiment;

FIG. 1a is an enlarged view of the central portion of the girth in FIG. 1;

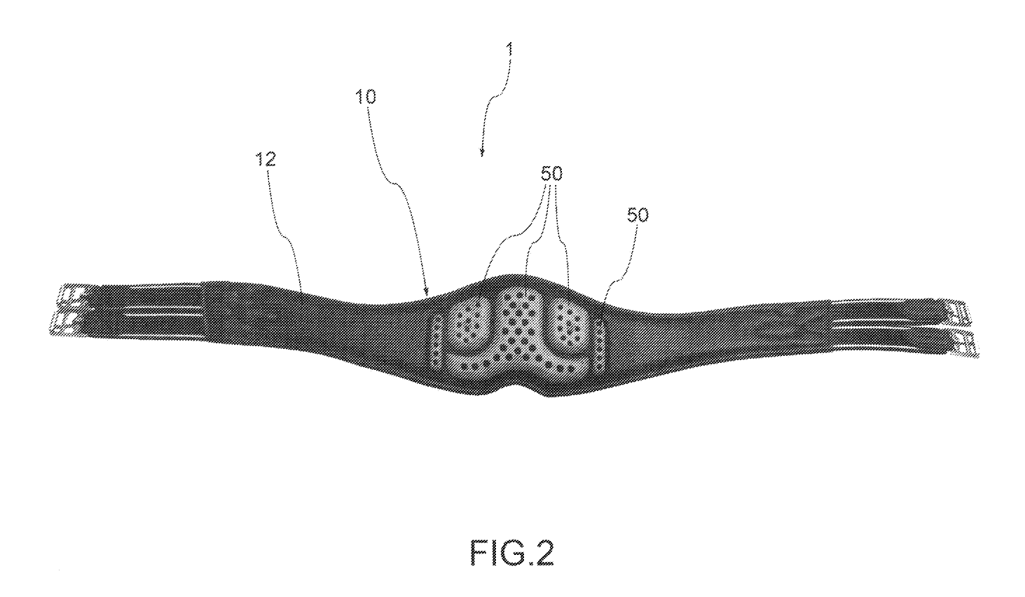

FIG. 2 is a view of the inside of the girth in FIG. 1;

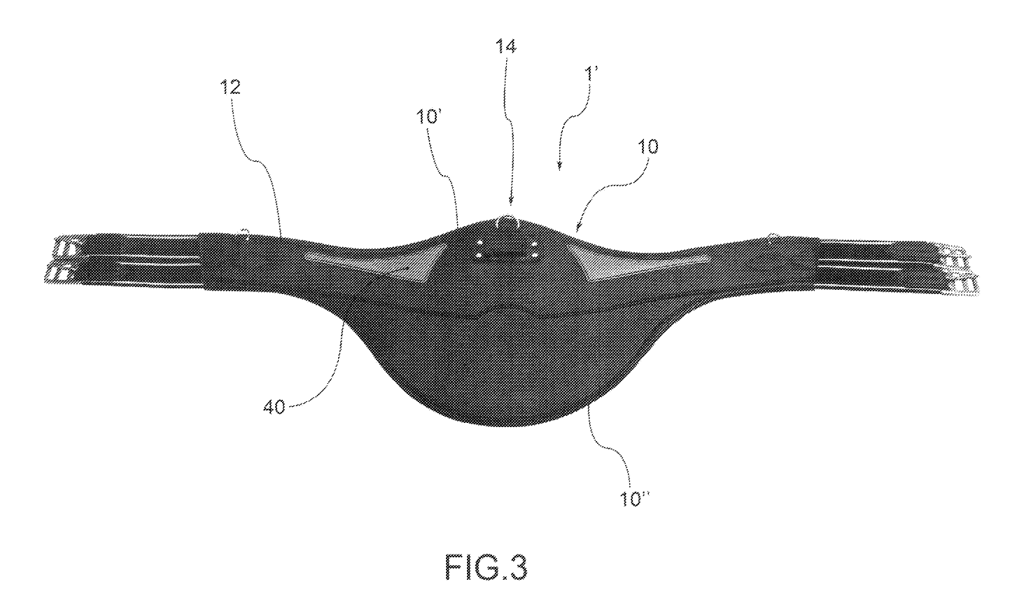

FIG. 3 is a view of the outside of the girth according to the invention, in a second embodiment;

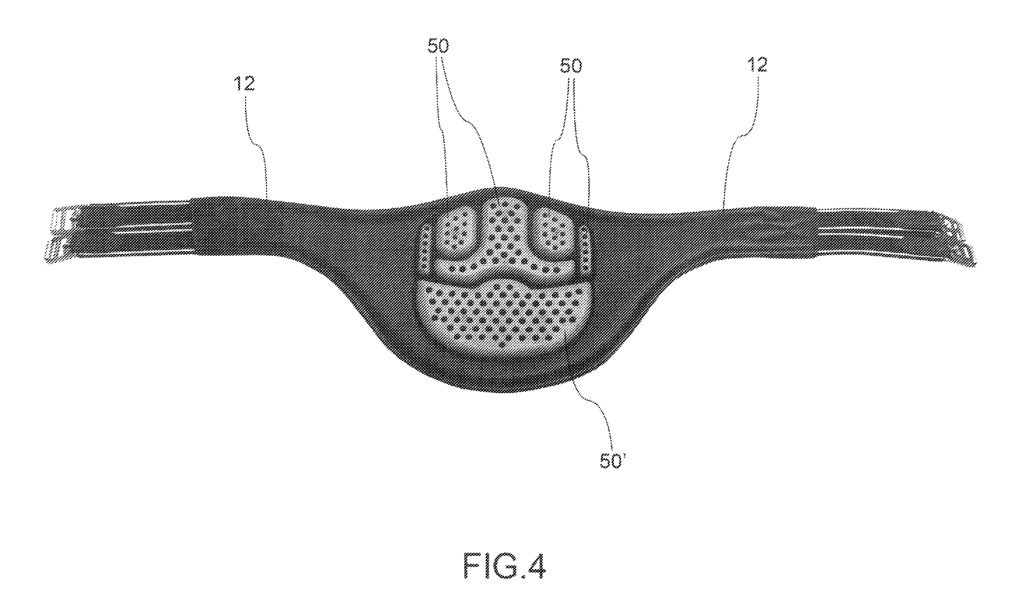

FIG. 4 is a view of the inside of the girth in FIG. 3.

With reference to the appended drawings reference numeral 1; 1′ globally denotes a girth according to the present invention.

The girth 1; 1′ comprises a central portion 10 from which two lateral bands 12 extend suitable to encircle the chest of the horse up to the connection to the saddle.

On the outer side of the central portion 10 a coupling element 14 is made for attaching to the loop of a strap of the martingale, harness or other operating instrument. Said coupling element 14 comprises a base 16 and a plate-shaped spring hook 18 which extends from said base 16 and which permits the insertion/extraction of the loop of the strap into and from the coupling element thanks to the elastic lifting of an end portion thereof relative to the base 16.

In a preferred embodiment, illustrated in detail in FIG. 1a, the plate-shaped spring hook 18 has a proximal portion 20 which rises from the base 16, an elongated intermediate portion 22, which extends substantially parallel to the base 16 or slightly inclined towards said base 16, so as to form with the base a lumen 24 for the passage of the loop of the strap to be coupled, and a distal portion 26 adjacent to the base 16, so as to laterally close the lumen 24.

The lumen 24 has a width slightly greater than the width of the strap to be coupled and a height from the base slightly greater than the thickness of the strap. The coupling element 14 is thus flattened towards the base 16.

Preferably, the distal portion 26 is shaped so as to act as a guide for the insertion of the loop of the strap into the hook by lifting the plate-shaped spring hook 18 and at the same time to prevent an accidental release of the strap from the coupling element. For example, said distal portion 26 forms a tooth defined by an inclined plane 26′ facing outwards and acting as a guide and by an inner stop wall 26″.

The proximal portion 20 is made in such a way as to give the spring hook 18 sufficient flexibility to permit a lifting of said hook 18 for the insertion and lateral extraction of the loop of the strap and at the same time a stiffness such as to prevent an accidental lifting of the hook.

In one embodiment, the coupling element 14 is made in a single body. Preferably, said coupling element is made of plastic material, for example filled Nylon, by injection moulding.

In one embodiment, the base 16 is attached to the central portion 10 of the girth 1, for example by screws or rivets 30.

In one embodiment, a ring 32 is also fixed to the central portion 10 of the girth 1; 1′, opposite the lumen 24 of the coupling element 14, suitable to be crossed by the loop of the coupled strap to keep the loop of the strap even more adherent to the girth 1; 1′.

The coupling element described above, thanks to its particularly flat shape, dramatically reduces the risk of accidentally spearing the crampon of the horseshoe.

Furthermore, such a coupling element is also advantageous for the user, as it allows the attachment of the harness, martingale and any operating instrument in a much simpler, faster manner and without taking off the saddle.

In one embodiment, outer paddings 40 are applied to the outer side of the girth 1, between the central portion 10 and the side bands 12 for example by over-moulding or stitching, which make the girth 1; 1′ softer and more flexible where it bends to embrace the side of the chest of the horse. For example, said outer paddings 40 are of an elongated triangular shape.

FIG. 2 shows the inside of the girth 1, in a first embodiment relative to a reduced-width girth. On said inner side inner paddings 50 in thermoplastic gel are over-moulded. Said inner paddings 50′offer considerable comfort for the horse, reduce the risk of pinching the axillary area, and prevent blocking breathing. The combination of the outer paddings 40 and the inner paddings 50 allows the girth 1 to adapt better to the morphology of the horse by reducing the compression of the muscles so as to improve blood supply and oxygenation and thus permit better performance.

FIGS. 3 and 4 show respectively the inner and outer side of the girth 1′ in a second embodiment relative to a girth of increased width in the central portion 10. In this case, the central portion 10 comprises a front element 10′ from which the side bands 12 extend and a rear extension 10″. Said rear extension 10″ is made separately from the front 10′ and is connected to it, for example by stitching. This way, the same extension can be used for different sizes of the girth 1.

It is to be noted that the rear extension 10″ is also provided, on the inner side, with an inner padding 50′ in thermoplastic gel.

The invention thus conceived thereby achieves the intended objectives.

Obviously, its practical embodiments may assume forms and configurations different from those described while remaining within the sphere of protection of the invention.

Furthermore, all the parts may be replaced with technically equivalent parts and the dimensions, shapes and materials used may be varied as required.

1-12. (canceled)

13. A riding girth comprises a central portion from which two lateral bands extend suitable to encircle the chest of the horse up to the connection to the saddle, wherein on the outer side of the central portion a coupling element is made for attaching the loop of a strap of the martingale, harness or other operating instrument, the coupling element comprising a base and a plate-shaped spring hook which extends from the base and which permits the insertion/extraction of the loop of the strap into and out of the coupling element thanks to the elastic lifting of an end portion thereof relative to the base.

14. Girth according to claim 13 wherein the plate-shaped spring hook comprises a proximal portion which rises from the base, an elongated intermediate portion, which extends substantially parallel to the base or slightly inclined towards the base so as to form with the base a lumen for the passage of the loop of the strap to be coupled, and a distal portion adjacent to the base, so as to laterally close the lumen.

15. Girth according to claim 14 wherein the lumen has a width slightly greater than the width of the strap to be coupled and a height from the base slightly greater than the thickness of the strap.

16. Girth according to claim 14 wherein the distal portion is shaped so as to act as a guide for the insertion of the loop of the strap into the hook by lifting the plate-shaped spring hook and at the same time to prevent an accidental release of the strap from the coupling element.

17. Girth according to claim 16 wherein the distal portion forms a tooth defined by an inclined plane facing outwards and acting as a guide and by an inner stop wall.

18. Girth according to claim 15 wherein the proximal portion is made in such a way as to give the spring hook sufficient flexibility to permit a lifting of the hook for the insertion and lateral extraction of the loop of the strap and at the same time a stiffness such as to prevent an accidental lifting of the hook.

19. Girth according to claim 13, wherein the coupling element is made in a single body.

20. Girth according to claim 19, wherein the coupling element is made of plastic.

21. Girth according to claim 13, wherein the base is attached to the central portion of the girth.

21. Girth according to claim 13, wherein a ring is also attached to the central portion of the girth opposite the lumen of the coupling element, suitable to be crossed by the loop of the coupled strap to keep the loop of the strap even more adherent to the girth.

22. Girth according to claim 13, wherein outer paddings are applied to the outer side of the girth between the central portion and the side bands, the outer paddings being suitable to make the girth softer and more flexible where it bends to embrace the side of the chest of the horse.

23. Girth according to claim 22, wherein outer paddings are applied to the outer side of the girth by over-moulding or stitching.

24. Girth according to claim 13, wherein inner paddings in thermoplastic gel are overmoulded on the inner side of the central portion.

25. Girth according to claim 13, wherein the central portion comprises a front element from which the side bands extend and a rear extension, the rear extension being made separately from the front element and being connected to this.

26. Girth according to claim 25, wherein the rear extension is connected to the front element by stitching.
